(19) United States
(12) Patent Application Publication
(10) Pub. No.: US 2013/0269791 A1
(43) Pub. Date: Oct. 17, 2013

(54) MODULAR VALVE SYSTEM

(71) Applicant: BUERKERT WERKE GMBH, Ingelfingen (DE)

(72) Inventors: Daniel HERRMANN, Blaufelden (DE); Volker LIENHARDT, Kupferzell/OT Westernach (DE); Johann GUNNESCH, Waldenburg (DE); Thomas SATTLER, Erzhausen (DE); Jan SCHLANDER, Rheinstetten (DE)

(73) Assignee: Buerkert Werke GmbH, Ingelfingen (DE)

(21) Appl. No.: 13/863,649

(22) Filed: Apr. 16, 2013

(30) Foreign Application Priority Data
Apr. 16, 2012 (DE) 20 2012 003 844.3

(51) Int. Cl. F16K 51/00

(52) U.S. Cl. CPC F16K 51/00
USPC 137/315.01

(57) ABSTRACT

A modular valve system includes a number of functional components such as valves, pressure regulators, adaptors and manifolds for controlling a fluid flow through said valve system, and at least two connecting blocks of different configurations, each associated to one of said functional components. Each one of said connecting blocks constitutes a functional unit together with one functional component mounted on a functional side of said connecting block. All connecting blocks are formed in a rectangular block shape and have an inlet and an outlet on two opposing end sides constituting an inlet side and an outlet side, respectively. The inlet sides of all connecting blocks are of identical configuration. The outlet sides of all connecting blocks are also of identical configuration, wherein outlet and inlet of neighboring, coupled connecting blocks are aligned with each other. Therefore, functional units can be directly coupled for establishing a fluid flow.

### FIELD OF THE INVENTION

The invention relates to a modular valve system.

### BACKGROUND

Control of a fluid flow through a valve system requires a plurality of different components. The design of a hydrogen supply for a fuel cell, for example, may involve a coupling of two valves, one pressure regulator, several pressure sensors, pressure gauges and safety valves. The use of a connecting block which is a compact component which already has all required fluid passages and ports for individual components already formed therein, conveniently enables densely packed and secure interconnections. However, there is a disadvantage in that each system requires the manufacture of its own connecting block.

### SUMMARY

The invention provides a modular system which allows a flexible selection of components and a modular interconnection thereof.

The modular valve system according to the invention has a number of functional components for controlling a fluid flow through said valve system, such as pressure regulators, adaptors, manifolds, pressure sensors or the like, and at least two connecting blocks of different configurations, each associated to one of said functional components, respectively. One connecting block and one functional component attached at a functional side of said connecting block constitute a functional unit. Each connecting block is formed in a rectangular block shape and has an inlet and an outlet, respectively, formed on two opposing end sides constituting an inlet side and an outlet side, respectively. The inlet sides of all connecting blocks are of identical configuration. Likewise, the outlet sides of all connecting block are of identical configuration. A plurality of functional units can be directly coupled and immediately fluidically connected to establish a fluid flow, the inlets and outlets of neighboring, coupled connecting blocks being aligned with each other so that they have a common central axis. Irrespective of the type of functional component mounted on the associated connecting block, complex fluid systems may be interconnected in a densely packed way since all ports to be connected within said system are standardized and all connecting blocks can advantageously be coupled to each other without any components alien to said system.

The inlet side dimensions (which preferably correspond to the outlet side dimensions) determine the size of the individual functional units so that any combination of different functional units can be implemented by simply joining the respective functional units. The system is insofar independent from dimensions and port arrangements of individual functional components as each respective connecting block determines the functional units' dimensions which are essential for establishing a flow connection.

In order to provide a unitary length dimension, at the length of the inlet or outlet side, respectively, is at least as wide as the a width of the widest functional component. With smaller functional components, space on the connecting block is traded off against identical dimensions of the inlet and outlet sides of all functional units.

The valve system according to the invention may comprise at least one functional unit having an ON-OFF valve as its functional component, and one functional unit having a pressure regulator or a proportional valve as its functional component. Connecting blocks associated to different functional units have fluid channels opening at different locations at their respective functional sides, these fluid channels being connected to the ON-OFF valve, the pressure regulator and the proportional valve, respectively.

The height of the connecting blocks may substantially correspond to the height of the inlet and outlet sides, respectively. The height is e.g. determined by the fluid path of the most complex functional component (i.e. by the connecting block having the greatest total length of all channels on its inside, for example). The fluid path determines the required number of vertically staggered fluid channels on the inside of the connecting block, for example. The maximum required height determines the unitary height of all connecting blocks.

Therefore, the connecting blocks of all functional units have the same length and the same height. The dimensions of the different connecting blocks perpendicular to the inlet or outlet sides, however, are varied and will depend on the specific associated functional component.

Each connecting block may have at least one mounting through hole, whereby the mounting holes of neighboring functional units which are coupled to enable a fluid flow are aligned with each other. Such a configuration enables an easy connection of the individual functional units, for example by inserting a continuous threaded shaft passing through each connecting block and by screw-fastening the ends of said shaft in order to hold the functional units together.

Each inlet side may have two mounting holes and one inlet hole, each hole being arranged on a straight line which extends diagonally across the inlet side. Here, the inlet is centrally arranged between the two mounting holes.

The configuration of the outlet side may be identical to the inlet side, with two mounting holes and an outlet hole arranged on a straight line extending diagonally across the outlet side, the outlet being preferably arranged in the center between the two mounting holes.

While the inlet and outlet sides of each connecting block are of identical configuration, their functional sides may be tailored to the specific functional component associated with the respective connecting block by providing fluid inlets and outlets and mounting holes tailored to the respective functional component. Here, the fluid ports and, for example, the mounting holes for the various functional components are typically arranged differently for different functional units on the functional side of the connecting block.

The connecting block has fluid channels formed at its inside which are e.g. tailored to the respective functional component associated to said connecting block and may be completely different in terms of design and location, depending on the respective function of the functional component. Here, the number and/or the arrangement of the fluid channels in connecting blocks which correspond to different functional components (i.e. components of different functionality) may differ.

The modular valve system according to the invention can also provided with connecting blocks for adaptors and manifolds which enable a two-dimensional fluid distribution. A connecting block may be configured to provide ports for a plurality of neighboring functional units, for example, in which case the respective connecting block has at least two neighboring areas corresponding to an inlet side and an outlet side at an opposing end side, respectively. On the inside of such connecting blocks, fluid channels are provided which establish a flow connection between said neighboring areas.

In principle, the modular valve system according to the invention allows the implementation of any desired fluid circuit. A connecting block for a functional component has only to be designed once. A functional component can always be used in combination with only one connecting block.

In addition to the inlet and the outlet, the connecting block may have other fluid inlets and outlets of any kind tailored to the specific function of the functional component. Each functional unit has, however, one inlet and one outlet which are arranged at the exact same position on the inlet and, respectively, outlet side of all functional units.

### BRIEF DESCRIPTION OF THE DRAWINGS

FIGS. 1 to 8 show examples of different functional units of a modular valve system according to the invention;

FIG. 9 is a schematic perspective view of a first connecting block for a functional unit of a modular valve system according to the invention;

FIG. 10 is a plan view showing the inlet side of the connecting block in FIG. 9;

FIG. 11 is a plan view showing the outlet side of the connecting block in FIG. 9;

FIG. 12 shows several variants of the mounting holes on the inlet side of the connecting block in FIG. 9;

FIG. 13 shows several variants of the mounting holes on the outlet side of the connecting block in FIG. 9;

FIG. 14 is a plan view of a lateral surface of the connecting block in FIG. 9;

FIG. 15 is a plan view of the functional side of the connecting block of FIG. 9;

FIG. 16 is a sectional view along a line XVI-XVI of FIG. 14;

FIG. 17 is a sectional view along a line XVII-XVII of FIG. 15;

FIG. 18 is plan view of the bottom surface of the connecting block of FIG. 9;

FIG. 19 is a schematic perspective view of a second connecting block for a functional unit of a modular valve system according to the invention;

FIG. 20 is a plan view of the bottom surface of the connecting block of FIG. 19;

FIG. 21 is a plan view of the inlet side of the connecting block of FIG. 19;

FIG. 22 is a plan view of the outlet side of the connecting block of FIG. 19;

FIG. 23 is plan view of the lateral surface of the connecting block of FIG. 19;

FIG. 24 is a plan view of the functional side of the connecting block of FIG. 19;

FIG. 25 is a sectional view along a line XXV-XXV of FIG. 23;

FIG. 26 is a sectional view along a line XXVI-XXVI in FIG. 24;

FIGS. 27 to 35 are different one- and two-dimensional combinations of several functional units.

### DETAILED DESCRIPTION

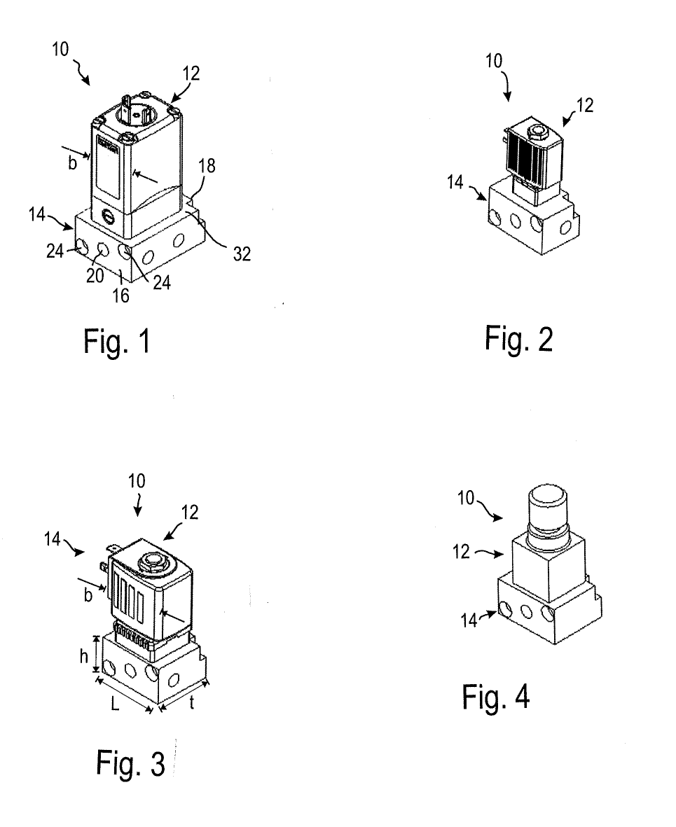

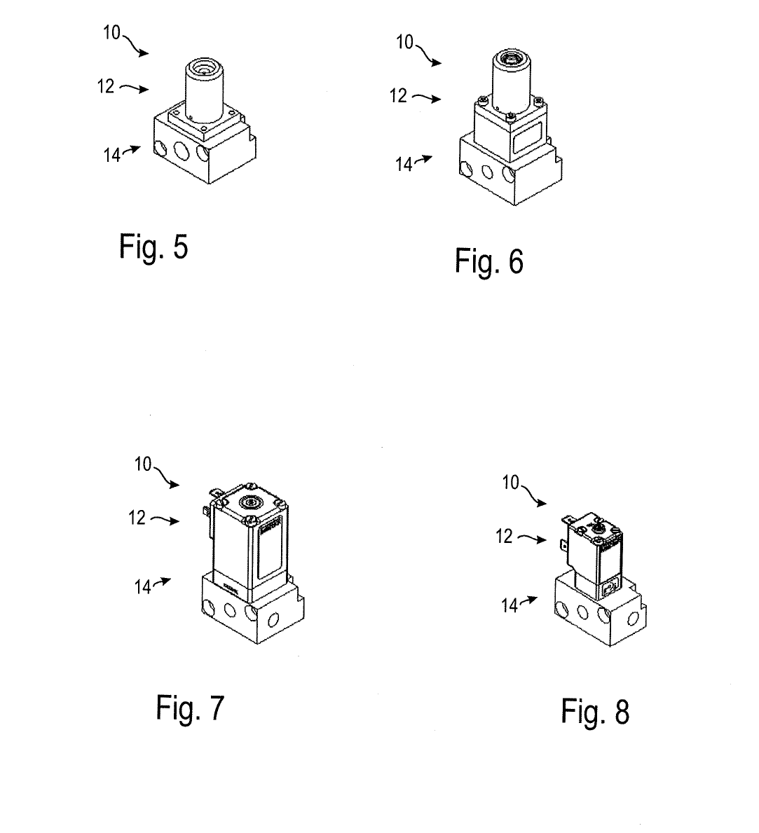

FIGS. 1 to 8 show different functional units 10 of a modular valve system. Each of the functional units 10 is comprised of a functional component 12 and a connecting block 14 directly coupled thereto.

The functional components 12 are ON-OFF valves (FIGS. 1 to 3), mechanical pressure regulators (FIGS. 4 to 6) or proportional valves (FIGS. 7 and 8), for example. Other functional components, such as pressure sensors, flow meters, pressure gauges, check valves or filters, may of course also be used.

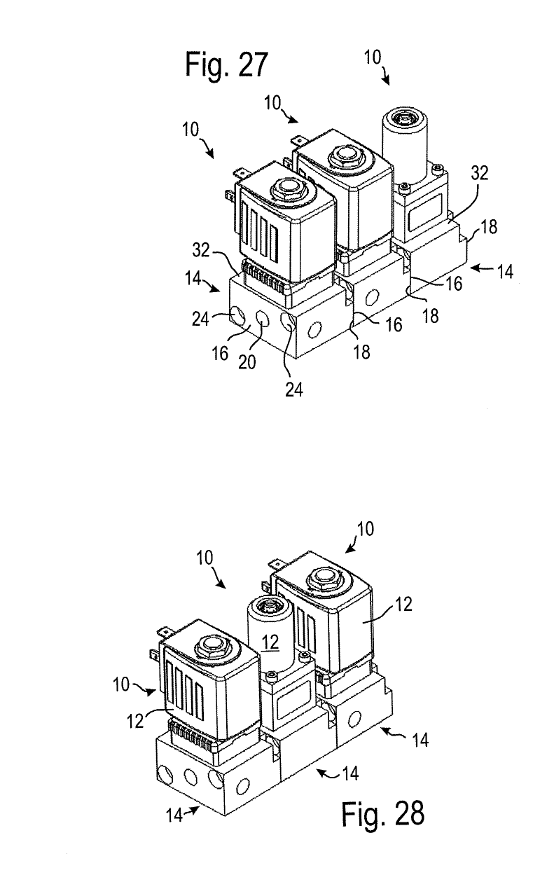

Moreover, the modular valve system is supplemented by connecting blocks such as adaptors or branching components which allow a combination of functional units in a one-dimensional chain or a two-dimensional matrix (see also FIGS. 27 to 35).

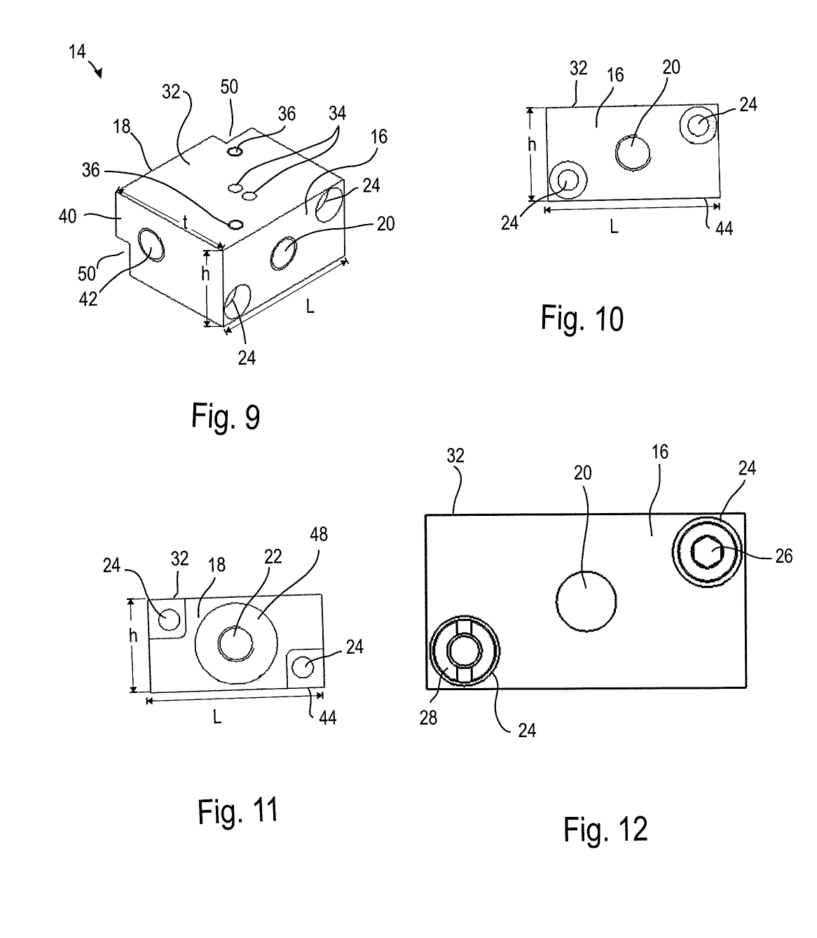

An exemplary first connecting block 14 is shown in FIGS. 9 to 18.

Each connecting block 14 is essentially formed in a rectangular block shape.

Each connecting block 14 has one end side constituting an inlet side 16 including a fluid inlet 20, and another end side opposite to said inlet side 16, which constitutes an outlet side 18 including a fluid outlet 22 (see e.g. FIG. 9).

In all functional units 10, even if they have functional components 12 with clearly different functions and/or outer shapes, the inlet sides 16 are identical in all associated connecting blocks 14. The outlet sides 18, too, are of perfectly identical configuration. This is true for their dimensions as well as for the location of the inlet 20 and, respectively, the outlet 22 on the inlet and, respectively, outlet sides 16, 18.

Even if the inlet side 16 may differ from the outlet side 18, the location of the inlets 20 and the outlets 22 should be identical on the inlet side compared to the outlet sides 16, 18, in order to allow a coupling of the inlet side 16 of a connecting block 14 to the outlet side 18 of an adjacent connecting block 14.

The length L of the inlet side 16 (and outlet side 18, respectively) is identical in all connecting blocks 14 of the modular valve system. Likewise, the height h which corresponds to the short side of the inlet side 16 and outlet side 18, respectively, is identical in all connecting blocks 14.

The length L is determined by the widest functional component 12 of the number of functional components 12 provided in the modular valve system. As can be seen from FIGS. 1 to 8, the width b of the functional components 12 varies (here, the width b refers to the dimension of the functional component 12 seen from the inlet side 16 and outlet side 18, respectively).

The height h and the length L of the inlet side 16 and outlet side 18, respectively, determine the maximum height h and the maximum length L of the connecting block 14.

The dimension of the connecting block 14 in terms of its depth t perpendicular to the inlet side 16 and outlet side 18, respectively, is, however, variable and depends on the specific functional component 12 associated to the connecting block 14.

In the illustrated example, inlet 20 and outlet 22 are located in the center of the inlet side 16 and outlet side 18, respectively, and extend vertically into the inside of the connecting block 14.

Each connecting block 14 has two mounting holes 24, each extending from the inlet side 16 to the outlet side 18 and passing straight through the connecting block 14. The two mounting holes 24 are arranged at the corners of the inlet side 16 and outlet side 18, respectively, in such a way that they are located on one straight line with the inlet 20 and the outlet 22, respectively, this line extending diagonally across the inlet side 16 and outlet side 18, respectively.

For a secure connection of different functional units 10, thread screws, for example, are inserted through all mounting holes 24 of each connecting block 14 of a respective combination.

In one variant two recesses are provided about the mounting hole 24 on the inlet side 16 for accommodating a head 26 of a cylinder-head screw so that said head does not project from the surface of the inlet side 16 (top right of FIG. 12).

In another variant two threaded shafts are used for the attachment, and one slotted nut 28 is fitted on the inlet side 16 (bottom left of FIG. 12).

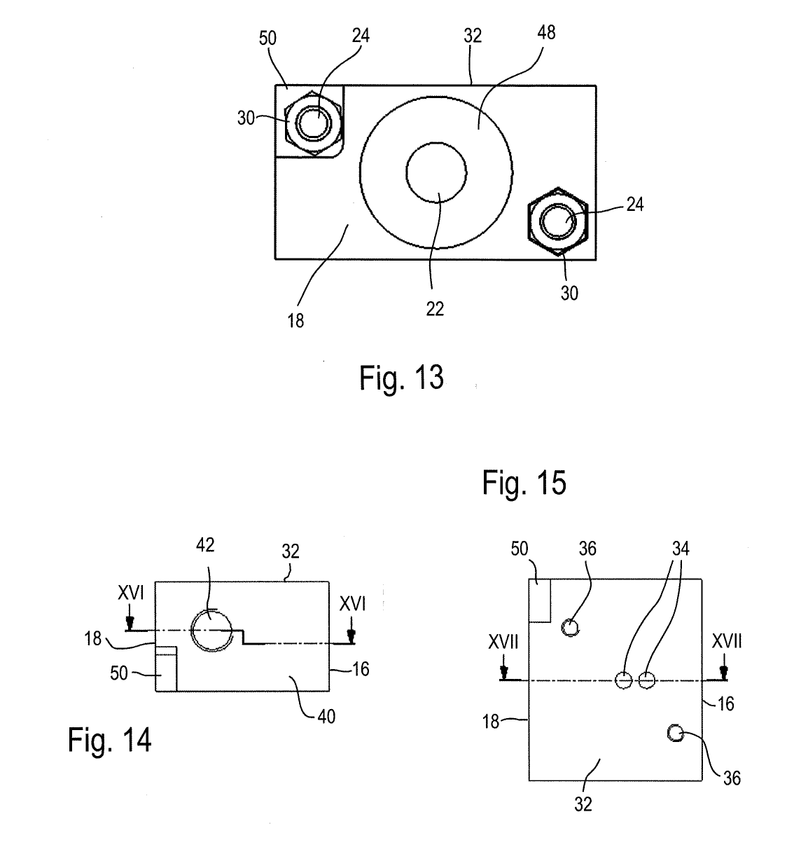

In one variant the outlet side 18 is also recessed in the area of the mounting holes 24 for accommodating a hexagonal nut 30 therein. A milled shape for accommodating a hexagonal nut 30 is shown in the top left corner of FIG. 13, while a hexagonal accommodation for a hexagonal nut in an ejection-molded connecting block 14 is shown in the bottom right corner of FIG. 13.

The specific configuration of the vicinity of the mounting holes 24 in the inlet side 16 or outlet side 18 lies with the person skilled in the art.

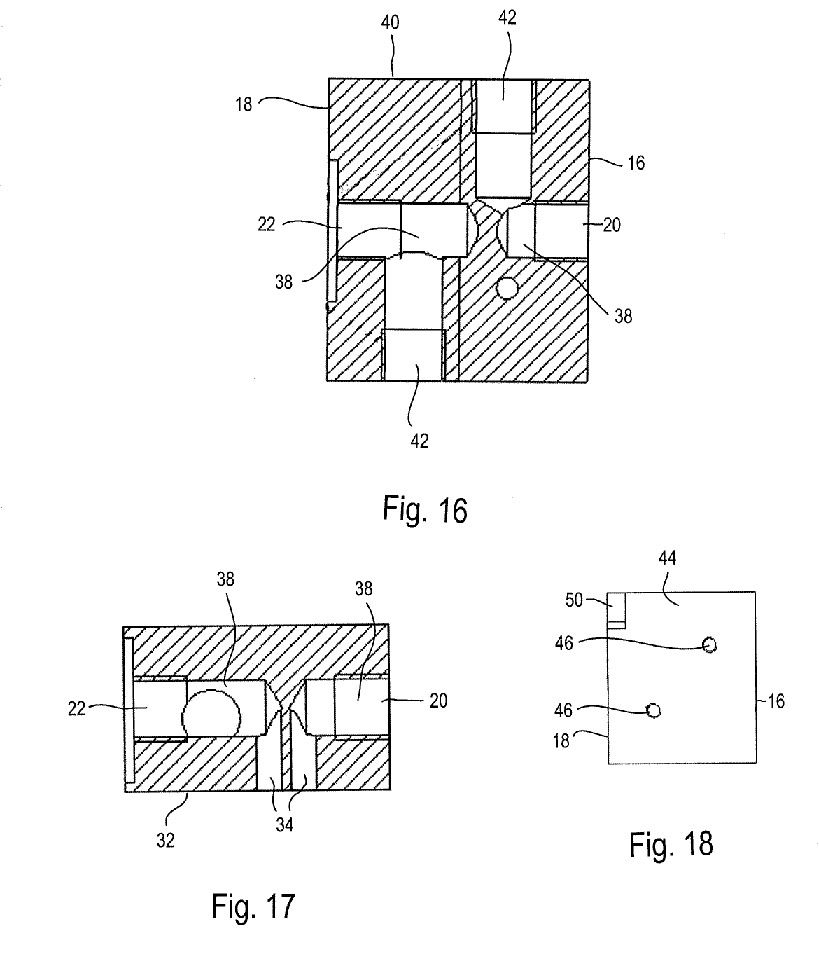

One of the two surfaces extending from the long sides L of the inlet side 16 and the outlet side 18 the connecting block 14 constitutes a functional side 32 onto which the respective associated functional component 12 is mounted and secured thereto (see FIG. 16, for example). The functional side 32 is tailored to the fluid ports and fastening points of each individual functional component 12. To this end, correspondingly arranged fluid channels 34 joining with individual, appropriately formed fluid channels 38 on the inside of the connecting block 14 and mounting holes 36 are provided on the functional side 32.

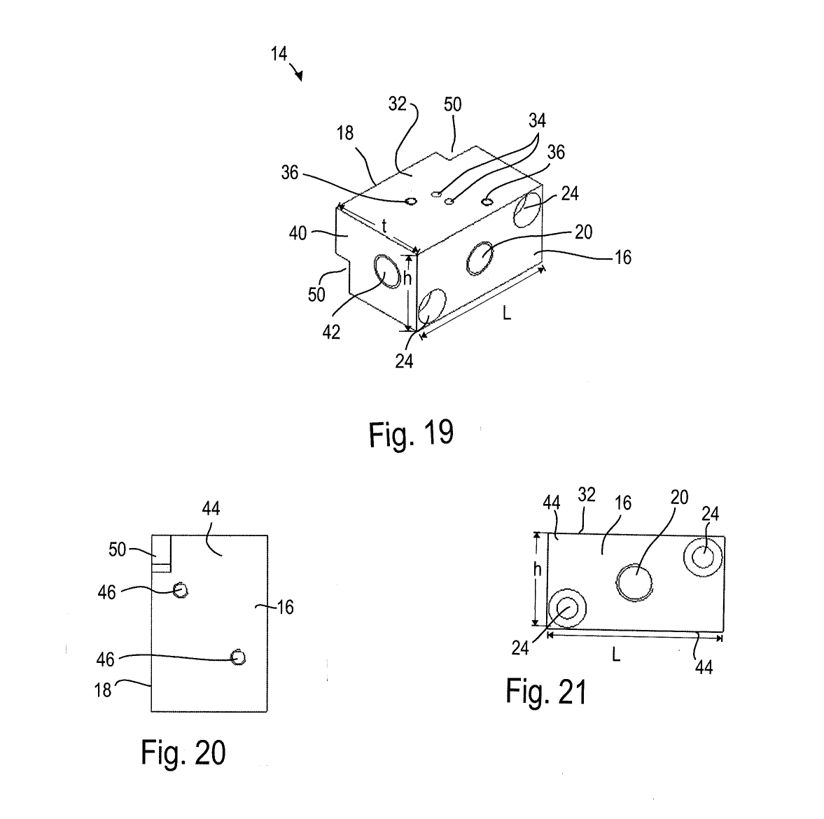

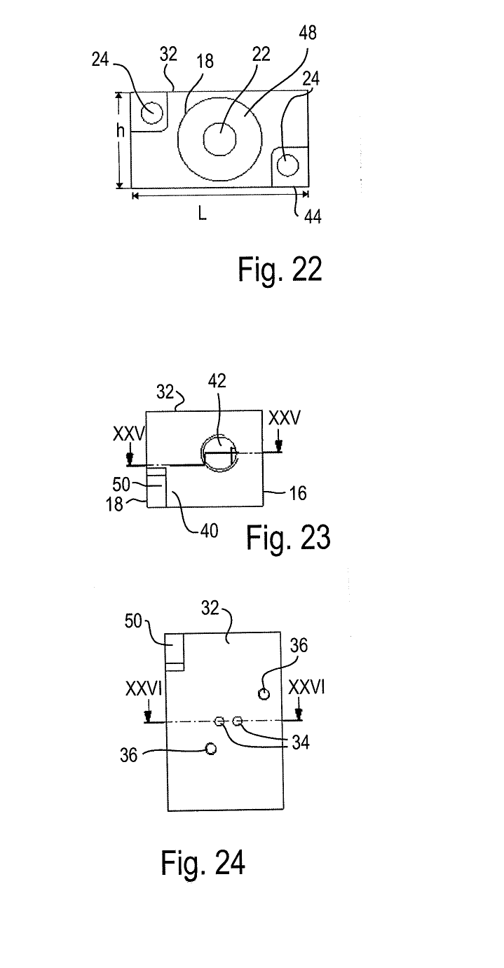

The different connecting blocks 14 of the different functional units 10 differ with respect to their functional sides 32. The arrangement of fluid channels 38 extending on the inside of the connecting block 14 also varies depending on the specific associated functional component 12 (see also FIGS. 19 to 26). The fluid channels 38 are in fluid communication with the inlet 20 and the outlet 22, respectively.

FIGS. 16 and 17 show the path of the fluid channels 38 from the inlet 20 to the outlet 22. As can be seen from FIG. 17, the inlet 20 is connected to a first fluid port 34 which opens into the functional side 32, while the outlet 22 is connected to a second fluid port 34 which opens into it. Therefore, each fluid flow from an inlet 20 to an outlet 22 takes place only via the functional component 12.

On the exemplary connecting block 14 of FIGS. 9 to 18, an ON-OFF valve, for example, may be fitted as a functional component 12 for enabling or disenabling a fluid communication between the inlet 20 and the outlet 22 via the channels 38 and the fluid ports 34.

The respective functional component 12 is screw-fastened, for example, at the respective connecting block 14 via the mounting holes 36.

The connecting block 14 shown has two additional fluid channels each opening in side walls 40 of the connecting block 14 in a port 42. Additional components such as pressure gauges or additional fluid inlets or outlets may be arranged there. These fluid channels as well as ports 42 are optional. Additional fluid channels and ports of this type may be provided in any number at each connecting block 14 at the discretion of the person skilled in the art and may be plugged, if necessary.

FIG. 18 shows a bottom surface 44 of the connecting block 14 including two mounting holes 46 which serve to fasten the connecting block 14 as such and therefore also the respective functional units 10 at other components.

The outlet 22 is surrounded by a recess 49 where a seal, for example an O-ring, may be placed in order to easily establish a fluid-tight connection between the functional units 10.

For a reliable distinction between the inlet side 16 and the outlet side 18 during the coupling process, two diagonally opposite corners of the connecting block 14 are recessed at the outlet side 18 in this case, forming rectangular recesses 50. This is of special advantage with a manufacturing process involving cutting. As an alternative, the connecting blocks 14 may be ejection-molded from plastics. In that case, a hexagonal shape as shown in the bottom right of FIG. 13 could be directly formed into the connecting block 14 without any recess. The recesses 50 may each coincide with accommodation elements for the hexagonal nuts 30 on the outlet side 18.

Basically, the connecting block 14 may be fabricated in any suitable way and from any suitable material (metal or plastics), for example by individual milling or by a molding process.

FIGS. 19 to 26 show a second connecting block 14 to be used with a proportional valve as the functional component 12, for example.

The inlet side 16 and the outlet side 18 are the same as in the above described connecting block 14 in terms of dimensions as well as locations of the inlets 20 and the outlets 22 and the mounting holes 24.

The first and second connecting blocks 14, however, differ in terms of their respective depth t perpendicular to their inlet and outlet sides 16, 18 and in terms of the location of the fluid ports 34 and the mounting holes 36 for the functional component 12 on the functional side 32. While in the illustrated example only the locations of the fluid ports 34 and the mounting holes 36 differ, it is also possible to vary their number as well as the number and the paths of the fluid channels 38 on the inside of the connecting block 14.

The identical configuration of the inlet sides 16 and outlet sides 18, respectively, of all connecting blocks 14 allow the individual functional units 10 to be connected for any combination of densely packed assemblies. Examples are shown in FIGS. 27 to 35.

FIG. 27 shows a combination of two ON-OFF valves and one mechanical pressure regulator.

FIG. 28 shows a combination where one mechanical pressure regulator is connected between two ON-OFF valves.

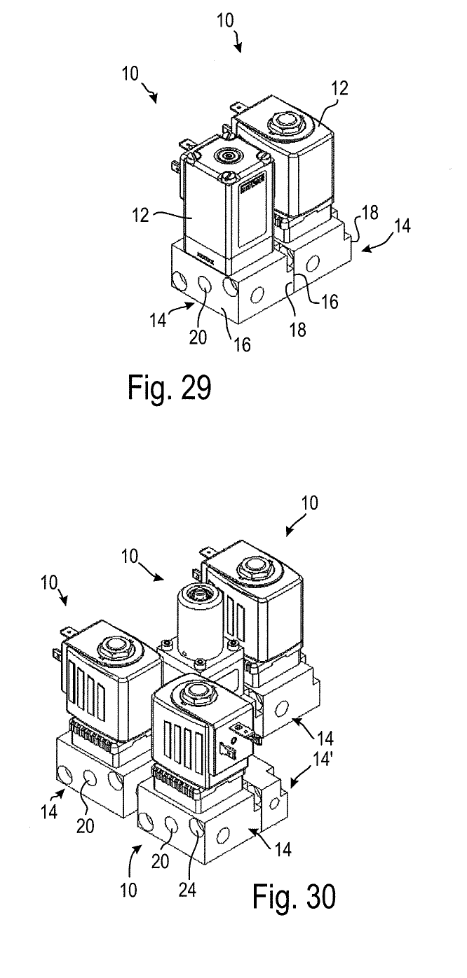

FIG. 29 shows a combination of one ON-OFF valve and one proportional valve.

In the assemblies shown in FIGS. 27 to 39, all functional units 10 are aligned one behind the other, so that a fluid flow extends from the inlet 20 of the frontmost functional unit 10 to the outlet 22 of the backmost functional unit 10.

FIG. 30 shows a two-dimensional interconnection of as much as four functional units 10, i.e. a combination of two ON-OFF valves connected in parallel for the application of two hydrogen storages, for example, and one mechanical pressure regulator connected to another ON-OFF valve.

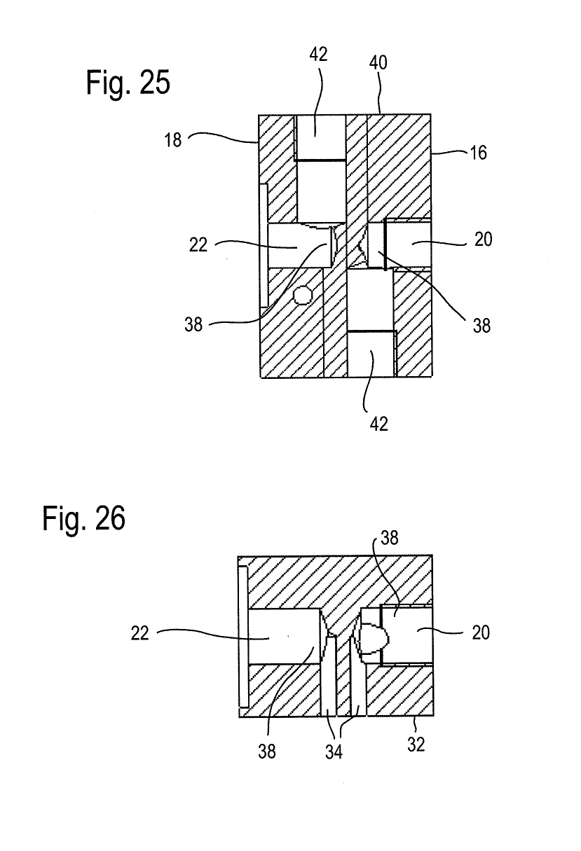

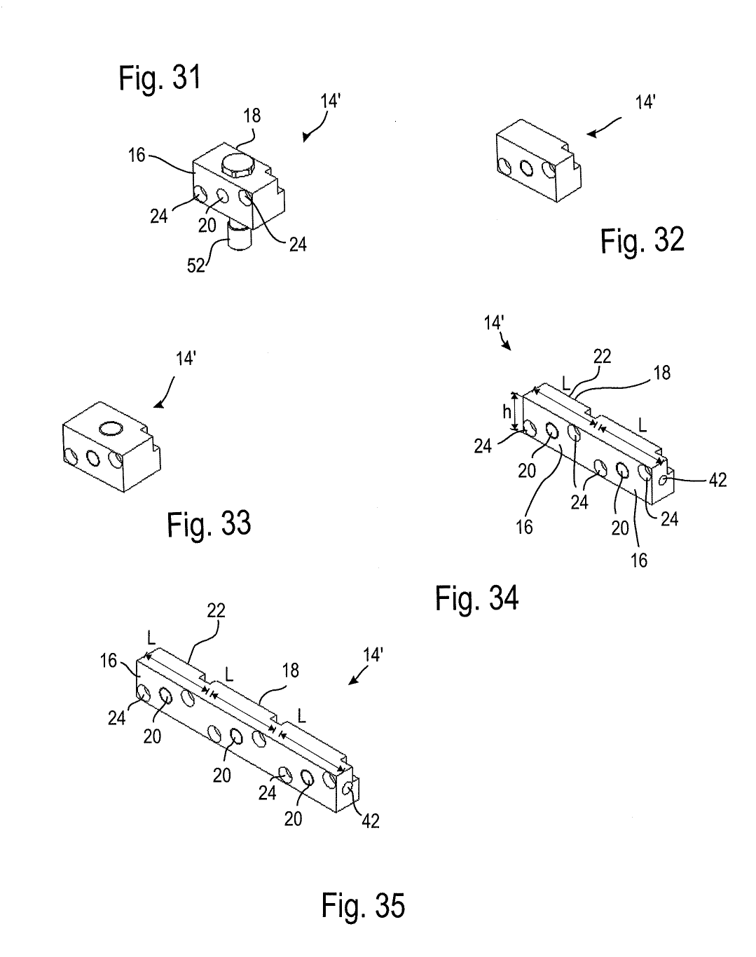

In order to implement such an arrangement, adaptor, manifold or branch connecting blocks 14′ are provided, examples of which are shown in FIGS. 31 to 25.

The adaptor connecting block 14′ according to FIG. 31 enables the use of a hollow screw 52 for a simultaneous mechanical connection and fluid communication.

FIG. 32 shows an adaptor connecting block 14′ having a filter or a check valve integrated therein.

FIG. 33 shows an adaptor connecting block 14′ for the adaptation of additional components having different threaded connections.

FIGS. 34 and 35 show examples of a double-branch component and a triple-branch component with two and, respectively, three inlets 20 but with only one outlet 22 (hidden at the back in the Figures). The dimensions of the inlet side 16′ and the outlet side 18′ are exactly the same as the height h of the connecting blocks 19 and correspond to a length with is greater than two times the length L of the inlet side 16 and the outlet side 18, respectively, of the connecting blocks 14. A continuous fluid channel on the inside of the connecting block 14′ (here only indicated by an end-side port 42) couples all inlets 20 to the outlet 22 so that a mixing of different gases is possible, for example, or two separate, independent supply trains may be provided.

Thus, the geometry of the connecting blocks 14 also exists in connecting blocks 14. Therefore, these components may be used without any problem in order to establish branches to additional functional units 10 of the modular valve system according to the invention, or transitions to other fluid flow systems.

The connecting blocks 14, 14′ as well as the functional units 10 shown are only examples. On the basis of the illustrated principle it is possible to form any functional unit 10 for a modular valve system.

The valve system according to the present invention preferably comprises at least one ON-OFF valve and one pressure regulator or one ON-OFF valve and one proportional valve as well as specific and different connecting blocks 14 associated to said ON-OFF valve, said pressure regulator and said proportional valve, with fluid ports 34 opening at different locations on the functional side 32 and connected to said ON-OFF valve, said pressure regulator and said proportional valve.

In the above examples, all functional sides 32 of the connecting blocks 14 carrying functional components 12 have the same orientation so that all functional components 12 are arranged side-by-side.

1. A modular valve system comprising:
a number of functional components such as valves, pressure regulators, adaptors and manifolds for controlling a fluid flow through a valve system, and
at least two differently formed connecting blocks, each of which being associated to a respective functional component and each of which having at least one functional side,
wherein one connecting block forms a functional unit together with one functional component mounted on a functional side of the connecting block, and
wherein all connecting blocks are formed in a rectangular block shape and have an inlet and an outlet on two opposing end sides forming an inlet side and an outlet side, respectively, and
wherein the inlet sides of all connecting blocks are of identical configuration, and the outlet sides of all connecting blocks are of identical configuration, so that functional units can be directly coupled and fluidically connected to establish a fluid flow between them, wherein outlets and inlets of neighboring, coupled connecting blocks are aligned with each other.

2. A valve system according to claim 1, wherein functional components are at least one of valves, pressure regulators, adaptors and manifolds.

3. A valve system according to claim 1, wherein the length of the inlet and outlet side, respectively, is at least as large as a width of the widest functional component.

4. A valve system according to claim 1, wherein said valve system has at least one functional unit including an ON-OFF valve as a functional component, and one functional unit including a pressure regulator or a proportional valve as a functional component, wherein connecting blocks associated to different functional components have fluid channels opening at different locations on the functional side to which the ON-OFF valve, the pressure regulator and the proportional valve, respectively, are coupled.

5. A valve system according to claim 1, wherein each connecting block has at least one continuous mounting hole, wherein the mounting holes of neighboring, fluidically connected functional units are aligned to each other.

6. A valve system according to claim 1, wherein each inlet side has two mounting holes, and wherein one inlet located on a straight line extends diagonally across the inlet side.

7. A valve system according to claim 1, wherein each outlet side has two mounting holes, and one outlet located on a straight line extends diagonally across the outlet side.

8. A valve system according to claim 1, wherein the functional side of each connecting block has fluid ports tailored to the respective functional component associated to said connecting block as well as mounting holes, and wherein the fluid ports for different functional components are arranged differently.

9. A valve system according to claim 1, wherein each connecting block has fluid channels formed therein which are tailored to the respective functional component associated to said connecting block,

10. A valve system according to claim 9, wherein at least one the number and the arrangement of the fluid channels in connecting blocks associated to different functional components are different.
